(19) United States
(12) Patent Application Publication
(10) Pub. No.: US 2002/0036858 A1
(43) Pub. Date: Mar. 28, 2002

(54) Writing servo sectors to a disc drive using offset heads

(75) Inventors: Qiang Bi, Singapore (SG); Xiong Liu, Singapore (SG); Kevin A. Gomez, Singapore (SG); Jimmy T. Pang, Singapore (SG); ChoonKiat Lim, Singapore (SG)

Correspondence Address: Bill D. McCarthy, CROWE & DUNLEVY, 1800 Mid-America Tower, 20 N. Broadway, Oklahoma City, OK, 73102-8273, US

(73) Assignee: Seagate Technology LLC

(21) Appl. No.: 09/846,426

(22) Filed: Apr. 30, 2001

Related U.S. Application Data
(60) Provisional application No. 60/235,592, filed on Sep. 27, 2000.

(51) Int. Cl. G11B 21/02; G11B 5/596

(52) U.S. Cl. 360/75; 360/78.04; 360/78.14

(57) ABSTRACT

A disc drive including rotatable disc surface adjacent a positionable read/write head having a write element offset from a read element in one direction across the rotatable disc surface from an outer diameter of the disc surface to an inner diameter of the disc surface for writing head position control fields by steps for controlling writing of second head position control fields on a second portion of the disc surface while reading head position control fields written on a first portion of the disc surface, using the read element, to augment position-control of the write element being controlled by a position information writing apparatus, while writing the second head position control field to the second portion of the disc surface.

### RELATED APPLICATIONS

This application claims priority to United States Provisional Application No. 60/235,592 filed Sep. 27, 2000, entitled Servo Track Writing Using Offset Head.

### FIELD OF THE INVENTION

This invention relates generally to the field of magnetic data storage devices, and more particularly, but not by way of limitation, to a method for writing offset servo data to the disc drive and a disc drive with offset servo data written by the method.

### Background

Disc drives are used for data storage in modern electronic products ranging from digital cameras to computer systems and networks. A typical disc drive includes a head-disc assembly (HDA), housing the mechanical portion of the drive, and electronics in the form of a printed circuit board assembly (PCB), mounted to an outer surface of the HDA. The PCB controls functions of the HDA and provides a communication link between the disc drive and its host.

Typically, a HDA comprises a magnetic disc surface affixed to a spindle motor assembly for rotation at a constant speed and an actuator assembly positionably controlled by a closed loop servo system. The actuator assembly supports a read/write head that traverse generally concentric magnetic tracks radially spaced across the disc surfaces. Disc drives using magneto resistive heads typically use an inductive element to write data to the tracks in the form of magnetic flux transitions and a magneto resistive element to read data, such as servo data, from the track during drive operations. Servo data is typically written to the track during the manufacturing process by a servo track writer and is used by the closed loop servo system for controlling read/write head position during drive operations.

Continued demand for disc drives with ever-increasing levels of data storage capacity and data throughput have led disc drive manufacturers to seek ways to increase the storage capacity of each disc surface and improve overall operating efficiencies of the disc drive. High performance disc drives of the present generation typically achieve aerial bit densities measured in several gigabits per square centimeter, Gbits/cm². Higher recording densities can be achieved by increasing the number of bits stored along each track or bits per inch (BPI), and/or by increasing the number of tracks per unit width or tracks per inch (TPI) across each disc. Increased BPI generally requires improvements in the read/write channel electronics to enable the data to be written (and subsequently read) at a correspondingly higher frequency.

Providing higher TPI generally requires improvements in servo control systems to enable the heads to be more precisely positioned relative to the tracks, and corresponding improvements in servo write technology used to create the geometry of the tracks on the disc surface. With increasing TPIs, servo track writers (STW) face greater challenges to effective servo writing. Prior art STW, based on laser position-sensing feedback control loops, were effective in establishing track geometries on disc surfaces for disc drives having sufficient track pitch to mask disturbances occurring during the servo write operation. However, with increasing TPI, head disturbances (resulting from, for example, windage or suspension vibration), and disc disturbances (resulting from factors such as disc flutter or spindle bearing cage frequencies) cause the disc to move relative to the head, thereby impacting the ability of the STW to continually and repeatedly write servo tracks of sufficient quality to support the increased TPI. As such, challenges remain and a need persists for the capability of economically and effectively writing servo data to disc surfaces of disc drives supporting ever higher track pitches, such as beyond 100,000 TPI.

### SUMMARY OF THE INVENTION

The present invention provides a method for writing servo sectors to a disc surface of a disc drive using an offset head technology, and for a disc drive having head position control fields written to a first portion of the disc surface for adjusting to effects of selected frequency components that positionably displace a read element of a read/write head relative to the first portion while a write element of the read/write head writes track specific servo sectors that include head position control fields to a second portion of the disc surface, wherein the head position control fields of the second portion controls position of the read element in relation to the second portion while reading information from the second portion of the disc surface, and wherein the head position control fields of the second portion are offset from the head position control fields of the first portion, substantially circumferentially aligned to the head position control fields of the first portion and substantially radially aligned to the head position control fields of the first portion.

In accordance with preferred embodiments, a disc drive is provided with a read/write head comprising a read element for reading information from the disc surface and a write element radially offset from the read element for writing information to the disc surface. Additionally, the write element is both substantially radially aligned and substantially circumferentially aligned to the read element and steps for writing a track specific servo sector to the rotatable disc surface. A position information writing apparatus writes the track specific servo sectors to a first portion of the disc surface while controlling the position of the write element relative to the first portion using a position signal derived from feedback from a laser beam measurement system.

Reading head position control fields from the first portion, the position information writing apparatus derives a head position control signal by combining the position signal derived from the laser beam measurement system with a head position control signal derived from the head position control fields. The information writing apparatus used the combined signal for controlling position of the write element while writing track specific servo sectors, including head position control fields, to a second portion of the disc surface. Combination of the head position control signal with the position signal of the laser beam measurement system provides substantial symmetry in geometry between the track specific servo sectors written to the first portion with the track specific servo sectors written to the second portion.

These and various other features and advantages, which characterize the present invention, will be apparent from a reading of the following detailed description and a review of the associated drawings.

### BRIEF DESCRIPTION OF THE DRAWINGS

FIG. 1 is a top plan view of a disc drive incorporating offset servo information written to a disc surface of the disc drive in accordance with a method of the present invention.

FIG. 2 is a functional block diagram of control circuitry of the disc drive of FIG. 1.

FIG. 3 shows an elevational view of a position information writing apparatus used in writing track specific servo sectors to data tracks of the disc drive of FIG. 1.

FIG. 4 is a plan view that shows head position control fields together with disc drive servo information comprising each servo sector of the data track of FIG. 1.

FIG. 5 provides a simplified block diagram of inputs and outputs of the position information writing apparatus of FIG. 3.

FIG. 6 is a flow chart of a method used to write radially and circumferentially aligned track specific servo sectors to the disc drive of FIG. 1.

### DETAILED DESCRIPTION

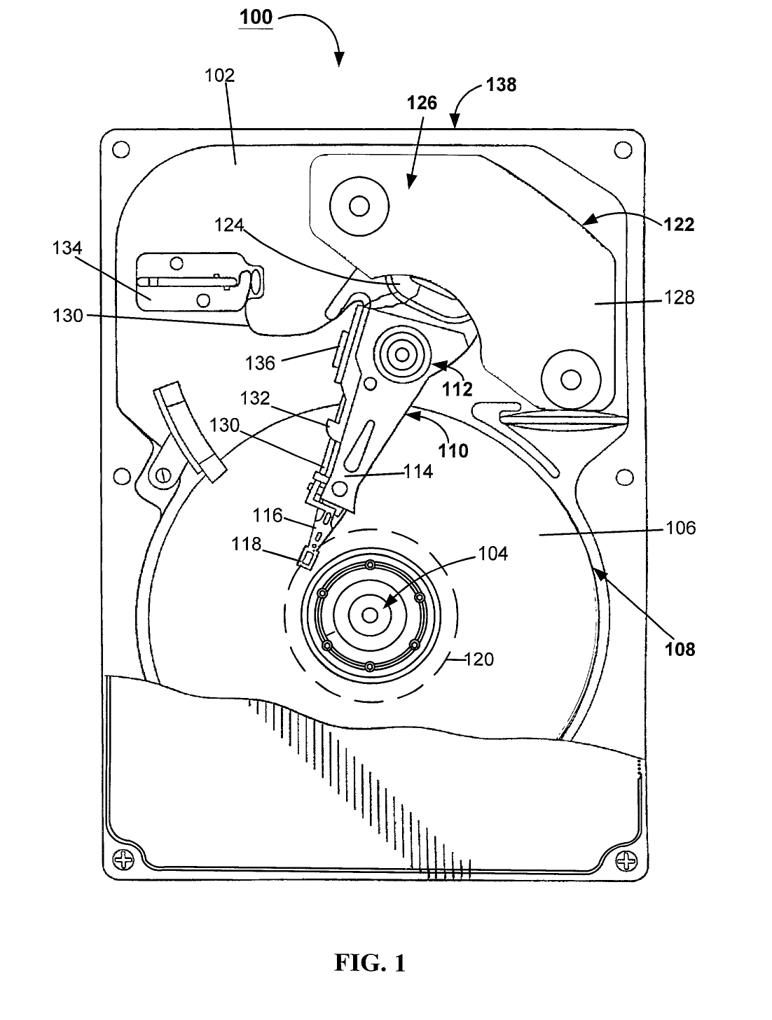

Referring to the drawings in general, and more particularly to FIG. 1, shown therein is a top view of a disc drive 100 constructed in accordance with the present invention. Numerous details of and variations for the construction of the disc drive 100 are not included in the following description as such are well-known to those skilled in the art and are believed to be unnecessary for the purpose of describing the present invention.

The disc drive 100 includes a basedeck 102 supporting various disc drive components, including a spindle motor assembly 104. The spindle motor assembly 104 supports at least one axially aligned rotatable disc surface 106 forming a disc stack 108. Adjacent the disc stack 108 is an actuator assembly 110 (also referred to as an “E-block” or a head stack assembly (HSA)), which pivots about a bearing assembly 112 in a rotary fashion. The HSA 110 includes at least one actuator arm 114 that supports a load arm 116. Each load arm 116 in turn supports at least one read/write head 118 (also referred to as head (s) 118) that correspond to each disc surface 106. Each head 118 is an offset head. That is, the head 118 has a write element (not separately shown) radially offset from a read element (not separately shown) by a predetermined distance with the read element positioned substantially circumferentially aligned to the write element. The predetermined distance separating the read and write elements is sufficient to assure the write element is offset from the read element in one direction only between the inner and outer diameter of disc surface 106, regardless of position of the load arm 116 relative to the disc surface 106. Each disc surface 106 is divided into concentric circular data tracks 120 (only one shown) over which the read/write heads 118 are positionably located, and on which track specific servo sectors (not shown) are written to embedded servo sectors (not separately shown). The embedded servo sectors separate a plurality of data sectors (not separately shown) for use by customers to store data.

The HSA 110 is controllably positioned by a voice coil motor assembly (VCM) 122, comprising an actuator coil 124 immersed in the magnetic field generated by a magnet assembly 126. A magnetically permeable flux path is provided by a steel plate 128 (also called a top pole piece) mounted above the actuator coil 124 to complete the magnetic circuit of the VCM 122. During operation of the disc drive 100, current is passed through the actuator coil 124, an electromagnetic field is setup, which interacts with the magnetic circuit of the VCM 122 to cause the actuator coil 124 to move relative to the magnet assembly 126 in accordance with the well-known Lorentz relationship. As the actuator coil 124 moves, the HSA 110 pivots about the bearing assembly 112, causing the heads 118 to move over each rotatable disc surface 106, thereby allowing the heads 118 to interact with the data tracks 120 of the disc surfaces 106.

To provide the requisite electrical conduction paths between the read/write heads 118 and disc drive read/write circuitry (not shown), read/write head wires (not shown) are affixed to a read/write flex circuit 130. Next, the read/write flex circuit 130 is routed from the load arms 116 along the actuator arms 114 and into a flex circuit containment channel 132, then on to a flex connector body 134. The flex connector body 134 supports the flex circuit 130 during passage of the read/write flex circuit 130 through the basedeck 102 and into electrical communication a disc drive printed circuit board assembly (PCBA) (not shown) mounted to the underside of the basedeck 102. The flex circuit containment channel 132 also supports read/write signal circuitry, including preamplifier/driver (preamp) 136 used to condition read/write signals passed between the read/write circuitry (not shown) and the read/write heads 118. The disc drive PCBA provides the disc drive read/write circuitry, which controls the operation of the heads 118, as well as other interface and control circuitry for the disc drive 100.

The disc drive 100 has two primary assemblies, the PCBA (not shown) and a head disc assembly (HDA) 138 attached to the PCBA. Typically, included within the HDA 138 are the HSA 110, the VCM 122 and the disc stack 108.

The read element radially offset from the write element of the heads 118 engenders the use of head position control fields of each track specific servo sector (not separately shown) of a first data track 120 to provide input to the read element (not separately shown) for controlling the position of the read element in relation to the first data track 120 while the write element (not separately shown) of the read/write head 118 writes data to a second data track 120. In addition to being offset, the write element is substantially radially aligned and substantially circumferentially aligned to the read element of each head 118.

By virtue of the read/write head 118 being an offset head, the track specific servo sectors of the first data track 120 of a second portion (not separately shown) of the disc surface 106, is offset from the track specific servo sectors (not separately shown) of the first data track 120 of a first portion (not shown) of the disc surface 106. The offset distance separating the first data track 120 of the first portion and the first data track 120 of the second portion is substantially equal to the distance separating the read element from the write element within the read/write head 118. Additionally, the head position control fields of the first data track 120 of the second portion of the disc surface 106, is substantially radially and substantially circumferentially aligned to the head position control fields of the first data track 120 of the first portion of the disc surface 106.

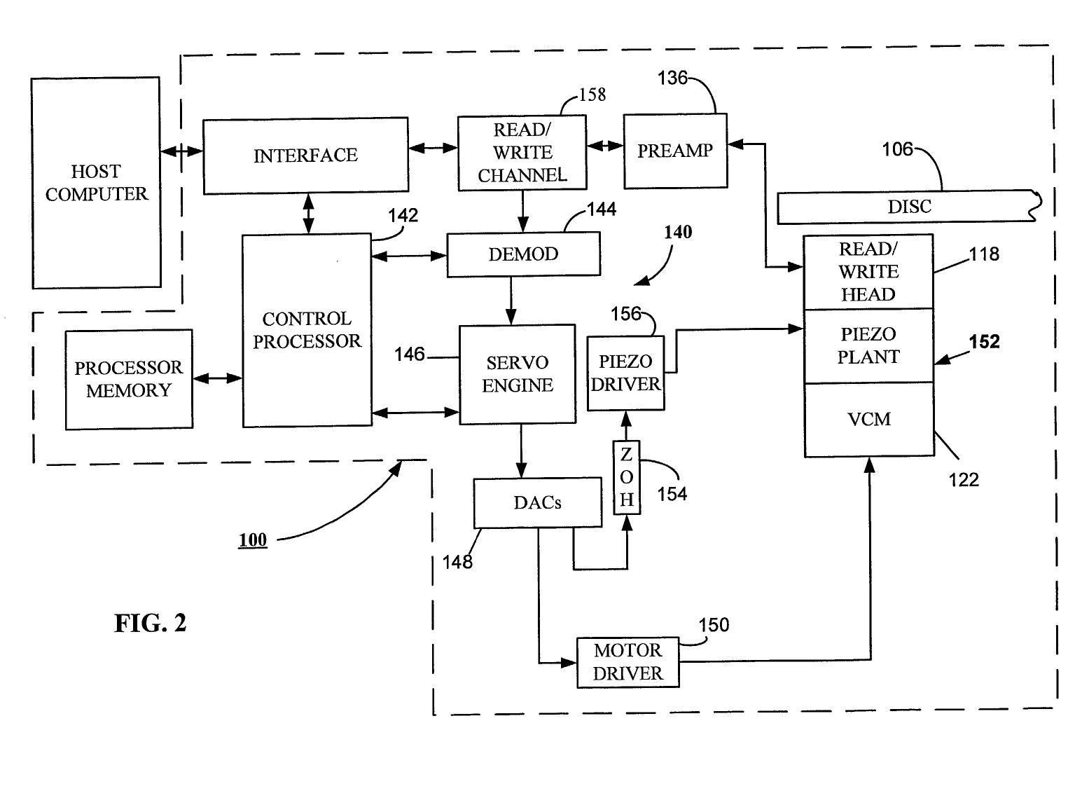

Turning to FIG. 2, positional control of the offset heads 118 is provided by a closed loop servo circuit 140 that includes the control processor 142, a demodulator (demod) 144, an application specific integrated circuit (ASIC) hardware-based servo controller (“servo engine”) 146, a set of digital to analog converters (DACs) 148 and a motor driver circuit 150. The components of the closed loop servo circuit 140 discussed to this point are utilized to facilitate track following algorithms for the VCM 122.

The demodulator 144 conditions the head position control fields transduced from the disc surface 106 to provide position information of the head 118 relative to the data track 120 (of FIG. 1). The servo engine 146 generates servo control loop values used by control processor 142 in generating command signals such as velocity based seek signals used by VCM 122 in executing seek commands, and to maintain position of the HSA 110 (of FIG. 1) during data transfer operations. The command signals are converted by the DACs 148 to analog control signals for use by the motor driver circuit 150 in directing track following and seek functions of the HSA 110 (of FIG. 1).

In an alternate preferred embodiment, disc drive 100 has a secondary actuator in the form of a piezoelectric transducer based piezo plant 152 attached to the read/write head 118. For the piezo plant 152 embodiment, positioning voltages from the servo engine 146 are received from the DACs 148 into a zero-order hold device 154 (ZOH 154) that continually maintains the positioning voltage level provided to a piezo driver 156 until the positioning voltage is updated. The piezo driver 156 drives the piezo plant 152 for fine positioning of the read/write head 118 relative to the data track 120 (of FIG. 1). Either the VCM 122 or the piezo plant 152 can be used by the present invention to offset head disturbances (resulting from windage and suspension vibration as an example), or disc disturbances (resulting from factors such as disc flutter or spindle bearing cage frequencies) that cause the disc surface 106 to move relative to the read/write head 118 during the servo write process.

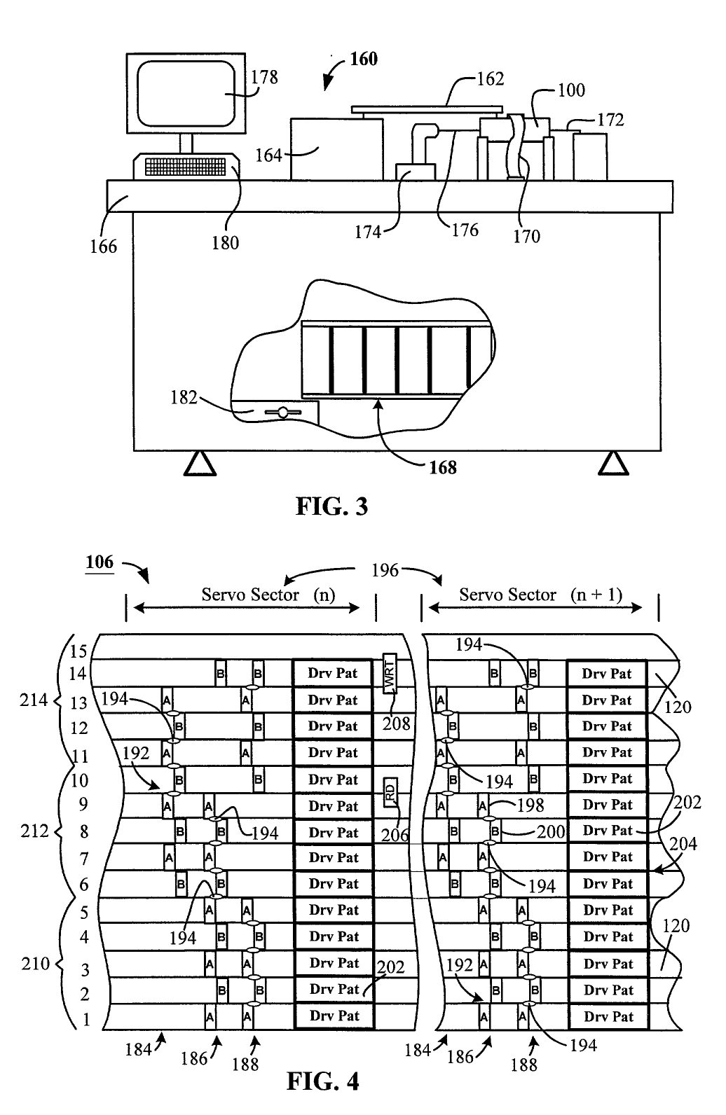

With inclusion of a read/write channel, such as 158, and a closed loop servo circuit, such as 140, within a position information writing apparatus, such as 160 of FIG. 3, track specific servo sectors can be written to the data track 120 (of FIG. 1) during the servo write process.

FIG. 3 shows the disc drive 100 mounted on the position information writing apparatus 160. In a preferred embodiment, the position information writing apparatus 160 is a servo track writer (STW). As recognized by those skilled in the art, the mechanical configurations of servo track writers vary to accommodate a particular disc drive and the manufacturing processes selected to produce that particular disc drive. The mechanical presentation of STW 160 has been elected to add clarity and brevity in disclosing the subject matter of the invention. The elected structure is but one of multiple configurations in which numerous changes would readily suggest themselves to those skilled in the art, without changing the functionality of the STW 160.

Included in the STW 160 is a push-pin 162 connecting the HSA 110 (of FIG. 1) of the disc drive 100 to a positioning apparatus 164 (also referred as positioner 164). The push-pin 162 structurally connects the HSA 110 (of FIG. 1) to the positioner 164, which in turn controls movement of the HSA 110 (of FIG. 1) during the process of writing the track specific servo sectors to the disc surface 106 (of FIG. 2). During the servo track writing process, the disc drive 100 is supported by the STW support surface 166 of the STW 160. The disc drive 100 is connected to servo write control electronics 168 by servo write interface cable 170.

Once mounted and connected to the STW 160, a clock head 172 is positioned on the disc surface 106 to first, write a clock track on the disc surface 106 (of FIG. 2) and second, to read the clock track during the servo write process to synchronize a write clock (not separately shown) of the control electronics 168 to the clock track. In addition to the clock head 172, a laser based measurement system 174, utilizing a laser beam 176, provides sole closed loop feedback to the servo write control electronics 168 for positioning the HSA 100, relative to the laser based measurement system 174 while the track specific servo sectors are written to the first portion of the disc surface 106 (of FIG. 2).

Measurement of the distance between the read element and the write element of the read/write head 118 (of FIG. 2) is determined by the following method. The positioner 164 positions the HSA 110 (of FIG. 1) in a known location, for example biased against an outer crash stop (not separately shown) of the disc drive 100. The servo write control electronics 168 then generates and supplies to the read/write head 118 (of FIG. 2) a signal of predetermined frequency that is written to the disc surface 106 (of FIG. 2) by the write element of the read/write head 118 (of FIG. 2) to form a measurement track (not separately shown). Under control of the servo write control electronics 168, the positioner 164 advances the read element of the read/write head 118 (of FIG. 2) to the measurement track, while the laser based measurement system 174 measures the distance traveled by the read element of the read/write head 118 (of FIG. 2), as the HSA 110 (of FIG. 1) travels from the outer crash stop toward the spindle motor hub (not separately shown) of the spindle motor assembly 104 (of FIG. 1). Next, the width of the data track 120 (of FIG. 1) is determined by sweeping the read element of the read/write head 118 (of FIG. 2) across the measurement track while monitoring amplitude of the signal of predetermined frequency written to the measurement track. Finally, the distance traveled by the read element of the read/write head, as measured by the laser based measurement system 174, is divided by the measured width of the data track 120 (of FIG. 1) to determine the spacing, expressed as a number of adjacent data tracks 120 (of FIG. 1), between the read element and write element of the read/write head 118 (of FIG. 2). Based on the calculated number and spacing of data tracks 120 (of FIG. 1) to be written to the disc surface 106 (of FIG. 1), representing the spacing separating the read and write elements of the read/write head 118 (of FIG. 2), the STW 160 employs the laser based measurement system 174 and laser beam 176 as a closed loop feedback for positioning and controlling the position of the HSA 110 (of FIG. 1) while writing that number of data tracks 120 (of FIG. 1) to the disc surface 106 (of FIG. 1), thereby forming the first portion of the disc surface 106 (of FIG. 1). A result of the servo write process is identification of each specific data track 120 (of FIG. 1) through inclusion of a track identification number (not shown separately) encoded within a gray code portion (not shown separately) of the embedded servo information (not shown separately). As such, data tracks 120 (of FIG. 1) result from server write process.

For a preferred embodiment, the starting point for writing position control information on disc surface 106 (of FIG. 1) is determined by the direction of offset between the write element and the read element relative to the disc surface 106 (of FIG. 1). For read/write head 118 (of FIG. 2) configurations with a write element between the read element and the inner diameter of disc surface 106 (of FIG. 1), the starting position for writing the position control information on the first portion of the disc surface 106 (of FIG. 1) is adjacent the outer diameter of disc surface 106 (of FIG. 1). For read/write head 118 (of FIG. 2) configurations with a write element between the read element and the outer diameter of disc surface 106 (of FIG. 1), the starting point for writing the position control information on the first portion of disc surface 106 (of FIG. 1) is adjacent the inner diameter of disc surface (of FIG. 1).

Upon writing the number of calculated data tracks 120 (of FIG. 1) constituting the first portion of the disc surface 106 (of FIG. 1), the read element of the read/write head 118 (of FIG. 2) encounters the first head position control fields of the first track specific servo sectors written to the first track of the first portion of the disc surface 106 (of FIG. 1). At this point, the STW 160 ceases use of the laser based measurement system 174 and laser beam 176 derived position signal as the sole closed loop feedback input for controlling the position of the HSA 110 (of FIG. 1). Position information derived from the head position control fields written to the first portion of disc surface 106 (of FIG. 1) is combined with the laser beam 176 derived position signal to augment control of the HAS 110 (of FIG. 1) during the remainder of the write process. Runout errors written into the data tracks 120 (of FIG. 1) of the first portion (not shown) of the disc surface 106 (of FIG. 1) are identified via a position error signal (PES) read by the read element of head 118 (of FIG. 2) reading each encountered head position control field of the track specific servo sectors written to the first portion of the disc surface 106 (of FIG. 1), and compensated for by the use of an open loop zero acceleration path (ZAP) runout error compensation technique.

Based on the head position control fields of the first portion, read by the read element of the read/write head 118 (of FIG. 2), a head position control signal is derived and combined with the position signal of the STW 160 for use in controlling the position of the write element in relation to a second portion (not shown) while writing track specific servo sectors including head position control fields to the second portion of the disc surface 106 (of FIG. 1). The head position control signal includes ZAP feedforward compensation to augment the position signal of the STW 160 during the write operation of the second portion. As a first track (not shown) of the second portion of the disc surface 106 (of FIG. 1) is being written, the read element (not separately shown) of the head 118 (of FIG. 2) is naturally positioned on the first track of the first portion of the disc surface 106 (of FIG. 1). A head position signal (not shown), derived from the information written to the first track of the first portion of the disc surface 106 (of FIG. 1), is monitored to determine a ZAP value for first servo track being written to the second portion of the disc surface 106 (of FIG. 1), and likewise for each subsequent track being written. The Zap value for each track being written is obtained by summing head position feedback of the track being written, obtained using the read element of head 118 (of FIG. 2) reading the servo information previously recorded, with the stored ZAP data of the track being read. Throughout the writing process the laser based measurement system 174 and laser beam 176 are used to ensure that a predetermined average track spacing between adjacent data tracks 120 is maintained across the disc surface 106 (of FIG. 1). The head position control signals are used to compensate for position variations about the fixed laser position of the heads 118 (of FIG. 2).

FIG. 3 also shows a monitor 178 and station interface keyboard 180 connected to a servo station computer 182. The computer 182 controls overall station operations, provides process sequencing information, including track reference input to the servo write control electronics 168, and is used in diagnosing STW problems and communicates with an overall manufacturing control system (not shown).

FIG. 4 shows three sets of radially aligned, circumferentially aligned and adjacent servo wedge-windows 184, 186 and 188 extending across each data track of the disc surface 106. Each servo wedge window portion (not separately shown) of each data track 120 comprises a servo wedge 192, which comprises a head position control field 194 (HPCF 194). It is noted that each servo sector 196 comprises at least one HPCF 194. Additionally, each servo wedge 192 comprises an “A” burst 198, a “B” burst 200, a “C” burst (not shown) and a “D” burst (not shown). For clarity, only the “A” bursts 198 and “B” bursts 200 have been shown. The servo wedge-window portions of each data track 120 together with drive level servo information 202 (Drv Pat 202) comprise track specific servo sector 204. At least one data sector (not shown) lies between each pair of servo sectors 196 of each data track 120.

Head position feedback, provided by the HPCF 194, enables the detection and reporting of non-repeatable low frequency components such as spindle cage frequencies during the writing process, allows for compensation of these frequencies through utilization of a conventional feedforward block by feedforwarding these signals to the laser loop of the laser based measurement system 174 of FIG. 3, to reduce the effects of these disturbances, the result of which is improved concentricity of the data track 120. In other words, the relative movement of the head 118 (of FIG. 2) relative to the disc surface 106 (of FIG. 2) is monitored and partially compensated for by controlling the positioner 164 of the SWT 160 of FIG. 3. Additionally, ZAP values for data tracks 120 being written are stored and used to reduce or eliminate post ZAP time expended in down stream disc drive 100 (of FIG. 3) processing. The ZAP values for the tracks being written are obtained by summing head position feedback information obtained by the reader element of the head 118 (of FIG. 2) with stored ZAP data of the data track 120 being read by the reader element of head 118 (of FIG. 2). The head position feedback, provided by the read element of head 118 (of FIG. 2) is monitored while track specific servo sectors 204 are being written to any given data track 120.

FIG. 4 additionally shows the relative separation between the read element and the write element of the read/write head 118 by showing the reader position 206 relative to the writer position 208. Also, the reader position 206 identifies the positional relationship of the read element of the read/write heads 118 in relation to the HPCF 194 of the track specific servo sector 204, while the writer position 208 identifies the positional relationship of the write element of the read/write heads 118 to the data track 120. In other words, for a preferred embodiment shown by FIG. 4, the write element of the read/write head 118 is offset from the read element of the read/write head 118 a distance substantially equivalent to four data tracks 120.

The numbers 1 through 15 shown on the left side of FIG. 4 signify individual track numbers of data tracks 120 arranged on disc surface 106 from the outer diameter to the inner diameter in ascending order. The data track 120 signified by the number 1 is a first data track 120 at the outer diameter of disc surface 106. The data tracks 120 represented by numbers 1 through 5 comprise the first portion 210 of the disc surface 106. The servo sectors 196 of the first portion 210 result from application of the servo write process utilizing the use of STW 160 of (FIG. 3). In writing the number of calculated data tracks 120, constituting the first portion of the disc surface 106, the laser based measurement system 174 and laser beam 176 provide closed loop feedback information used to position and control the HSA 110 (of FIG. 1).

A second portion 212 of disc surface 106 includes data tracks 120 represented by the numbers 6 through 10. The servo sectors 196 of the second portion 212 of the disc surface 106 are a result of STW 160 (of FIG. 3) using the HPCFs 194 of the track specific servo sector 204 written to the first portion 210 of the disc surface 106, specifically, as the source for deriving compensated head position control signals. The compensated head position control signals are used for compensation of select frequencies written into the track specific servo sectors 204 of the first portion that occurred during the process of writing the track specific servo sector 204 onto the first portion of the disc surface 106. Combining the compensated head position control signals with the position signal of the STW 160 (of FIG. 3) constitutes the closed loop feedback control of the HSA 110 (of FIG. 1) while writing the track specific servo sector 204 of the second portion 212 to the disc surface 106, and for writing all subsequent track specific servo sectors 204 to the disc surface 106.

A third portion 214 of disc surface 106 comprises data tracks 120 represented by the numbers 11 through 15. The servo sectors 196 of the third portion 214 of the disc surface 106 are a result of STW 160 (of FIG. 3) using the HPCFs 194 of the track specific servo sector 204 written to the second portion 212 of the disc surface 106 in conjunction with the position signal of the STW 160 (of FIG. 3), derived from the laser based measurement system 174 (of FIG. 3) and laser beam 176 (of FIG. 3), as the source for closed loop feedback for positioning and controlling the position of the HSA 110 (of FIG. 1) while writing the position control information 204 of the third portion 214 to the data surface 106.

It is noted that during writing the first portion 210 of the disc surface 106, head disturbances, and disc disturbances causing the disc surface 106 to move relative to the read/write head 118 (of FIG. 2) are not measured because the read element of the read/write head 118 (of FIG. 2) cannot read a position signal until after the HPCFs 194 of the first portion 210 of the disc surface 106 have been written. Once HPCFs 194 of the first portion 210 are written to the disc surface 106, disturbance measurements can be made by the following procedure.

First, position the read element of the read/write head 118 (of FIG. 2) over a selected data track 120 having HPCFs 194, for example track 1 of first portion 210. Under control of the laser based measurement system 174 (of FIG. 3) and laser beam 176 (of FIG. 3) closed loop feedback, hold the read element stationery in relation to the STW 160 (of FIG. 3) via the push-pin 162 (of FIG. 3) connecting the HSA 110 (of FIG. 1) of the disc drive 100 (of FIG. 3) to the positioner 164. Next, the HPCFs 194 (of FIG. 4) from a selected data track 120 are read to determine the position of the head 118 relative to the selected data track 120 and filtered to extract selected frequency components which are to be compensated for during writing operations of the first track, track 6, of the second portion 212. The source of the disturbances include disc flutter or a cage frequency component of the bearing assembly (not separately shown) of the spindle motor assembly 104 (of FIG. 1), and causes the disc surface 106 to move relative to the head 118 (of FIG. 2). Then, correction values with a compensation profile of the selected frequency components, to be augmented, are written to an open loop zero acceleration path table (ZAP table) (not shown).

When the STW 160 (of FIG. 3) begins writing the track specific servo sectors 204 onto a second or subsequent portion of the disc surface 106, appropriate correction values for the selected data track 120 to be written are drawn from the ZAP table. The correction values drawn from the ZAP table are in the form of a head position control signal (222 of FIG. 5), which are used as a feedforward compensation signal to augment the control loop to replicate mis-position of a head 118 (of FIG. 2) relative to the disc surface 106. That is, the frequency of disturbances that cause shifts in position of the disc surface 106 relative to the head 118 (of FIG. 2), or shifts in the position of the head 118 (of FIG. 2) relative to the disc surface 106, that occurred during writing of the HPCFs 194 by the STW 160 (of FIG. 3) to the first portion 210 of disc surface 106, are monitored from the read back of the prior written data track 120 and fed forward into the STW 160 (of FIG. 3) control loop to be written onto the HPCFs 194 of the data track 120 being written, which results in substantial similarity of geometric shape between the read data track 120 of disc portion (n) and its complementary written data track 120 of the disc portion (n+1).

Control loop 216 of FIG. 5, representing the input and output operations of STW 160, (of FIG. 3) shows reference signal 218 (ref.) as a reference input from the servo station computer 182 (of FIG. 3) to that servo write control electronics 168 in the form of a track number and serves as a coarse position signal for aligning the read/write head 118 to a selected data track 120 (not shown) of the disc surface 106. Fine position control of the read/write head 118 relative to the disc surface 106 during the servo track write process emanates from two sources. When the STW 160 (of FIG. 3) writes track specific servo sector 204 to the first portion 210 of the disc surface 106, fine position control is provided by the laser based measurement system 174. The laser based measurement system 174 provides a position signal 220 through summing junction 222 that combines with reference signal 218 at summing junction 224 and is passed to the servo control electronics 168. The servo control electronics provides a correction signal 226 to positioner 164, which adjusts the position of HSA 110 through push-pin 162 to correct the position of the head 118 relative to the disc surface 106.

When the STW 160 (of FIG. 3) writes track specific servo sector 204 to the second portion 212, both of FIG. 4, or any subsequent portion of the disc surface 106, fine position control is provided by the laser based measurement system 174 augmented by a correction signal in the form of a head position control signal 228. The head position control signal 228 is derived from head position control field 194 (of FIG. 4) written to the portion of the disc preceding the portion being written. That is, when head position control field 194 (of FIG. 4) is being written to second portion 212, the head position control field 194 (of FIG. 4) written to the first portion 210 (of FIG. 3) is used as a basis for generating the head position control signal 228. The head position control signal 228 is data track 120 (of FIG. 4) dependent and selected from an open loop zero acceleration path table 230 (ZAP 230). The STW 160 (of FIG. 3) uses the laser loop of the laser based measurement system 174 to position the heads at correct track spacing increments while using the ZAP 230 table to augment the position control of the HSA 110 to increase “parallelism” between the head position control fields 194 (of FIG. 4) of the data track 120 (of FIG. 4) being used to build the ZAP 230 and the head position control fields 194 (of FIG. 4) of the data track 120 (of FIG. 4) using the ZAP 230 for writing the head position control fields 194 to the data track 120 (of FIG. 4) being written.

Augmenting the laser loop of the laser based measurement system 174 with the head position control signal 228, through switch 232 into summing junction 222, which results in the track specific servo sectors 204 (of FIG. 4) of the data track 120 (of FIG. 4) being written having substantially the same written-in disturbances as the track specific servo sectors 204 (of FIG. 4) of the data track 120 (of FIG. 4) being used as the source for generating the head position control signal 228. By holding substantial parallelism between adjacent data tracks 120 (of FIG. 4), AC track squeeze is decreased.

Head disturbances 234, resulting from actions such as windage acting on the actuator arm 114 (of FIG. 1) or suspension vibration acting on the read/write head, are shown in FIG. 5 by force vector d1. Disc disturbances 236, resulting from factors such as disc flutter or spindle bearing cage frequencies, are shown in FIG. 5 by force vector d2. The contribution of force vectors d1 and d2 cause the disc surface 106 to move relative to the read/write head 118, or visa versa, when merged with PES 238 they form an input signal (PES+d1+d2) or the as read PES 240, used to generate compensation values held by ZAP table 230 for the track being written. A compensation signal (i.e., head position control signal 228), is fed forward into the STW 160 (of FIG. 3) control loop which substantially replicates effects imposed by d1 and/or d2, embodied with the PES signal 240, on the position of the read/write head 118 relative to the data track 120 selected for writing the track specific servo sectors 204 (of FIG. 4) including the head position control field 194 (of FIG. 4). The compensation input signal, in the form of the head position control signal 228, is formed from the PES 240 and the ZAP value of the track being read, selected from the ZAP table 230, as appropriate, during write operations of the servo write process.

It should be noted, the ZAP values for each data track 120 within each portion of the disc surface 106, subsequent to the first portion 210, such as 212 and 214 (all of FIG. 4), that track specific servo sectors 204 (of FIG. 4) are written to, are determined by head position measurements taken during the write process, used to derive PES 240 and combined with a stored ZAP value of the data track 120 (of FIG. 4) being read by the read element of the head 118 while the write element of the head 118 is writing the track specific servo sectors 204 (of FIG. 4) to the selected data track 120 (of FIG. 4). For example, if track 10 of the third portion 214 of FIG. 4 is being written, the head position information derived from the HPCfs 194 (of FIG. 4) of track 6 of section 212 (of FIG. 4) are used to determine the ZAP values for track 10. When the read element of head 118 is reading the HPCFs 194 (of FIG. 4) of track 6 of the second portion 212 (of FIG. 4), the PES of track 10 of the third section 214 (of FIG. 4) was recorded is recorded during the process of writing track 10 of the third section 214 (of FIG. 4). As such, the ZAP value for track 10 is the ZAP table value for track 6 plus the PES of track 10.

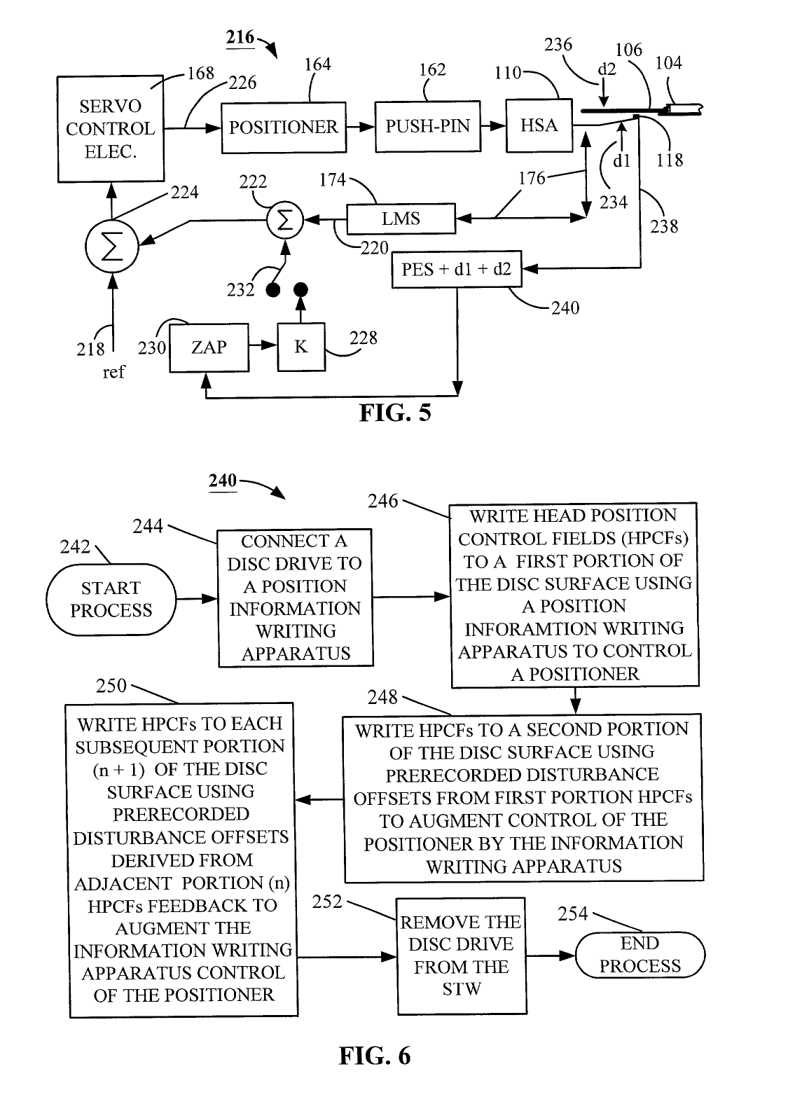

FIG. 6 shows servo write process 240 beginning with a start process step 242. The servo write process 240 continues with process step 244 where a disc drive (such as 100) is secured to a position information writing apparatus (for example a servo track writer STW) (such as 160), a push-pin (such as 162) is connected between a positioner (such as 164) and a head stack assembly (HSA) (such as 110), a servo write interface cable (such as 170) communicates with servo write control electronics (such as 168) and the disc drive is powered on and allowed to spin-up. The head position control fields (HPCFs) (such as 194) of a first portion (such as 210) are written to a disc surface (such as 106) of the disc drive at process step 246.

In writing HPCFs to the first portion of the disc surface, a clock head (such as 172) is positioned on the disc surface and a clock track is written to the disc surface. A coil (such as 124) of the HSA is energized to bias the HSA toward the positioner to take up slack in the push-pin. Next, the HSA is biased against an outer crash stop of the disc drive by the positioner and a write element of a read/write head (such as 118) of the disc drive writes a measurement track at a predetermined frequency. The STW utilizes a laser based measurement system (such as 174) and a laser beam (such as 176) to measure the distance a read element of the read/write head must travel prior to encountering the measurement track. Once the measurement track is encountered by the read element, the servo control electronics of the STW sweeps the read element of the read/write head across the measurement track as a means of determining the width of the data track, based on readback amplitude of the measurement track. Taking the distance traveled by the read element of the read/write head and dividing it by the measured width of the data track, the number of data tracks representing a separation between the write element and the read element of the read/write head is determined by the servo write control electronics.

The number of data tracks representing the separation between the write element and the read element of the read/write head constitutes the number of adjacent data tracks (such as 120) making up the first portion of the disc surface. Having written the first portion of the disc surface, the STW then proceeds to write track specific servo sectors (such as 204) aligned within a servo sector (such as 196), each track specific servo sector aligned to the corresponding track specific servo sectors written to the first portion of the disc surface. Each track specific servo sectors includes at least one servo wedge (such as 192) and drive level servo information (such as 202). Additionally, each track specific servo sector of each data track included in the first portion contains at least one HPCF (such as 194).

For purposes of invention disclosure and the appended claims, the phrase “position information writing apparatus” will be understood to include, but not limited to, a servo track writer, but could alternatively include a host computer configured to control an actuator or microactuator of the HSA 110 while writing the HPCFs 194 onto the servo sectors of the first portion of the disc surface under control of a measurement feedback loop other than a laser based measurement system, including a secondary measurement feedback system internal to the disc drive yet separate from the disc drive servo system used to direct operations of the disc drive.

Step 248, the next step of the servo write process, entails writing track specific servo sectors onto a second portion (such as 212) of the disc surface. The process of writing track specific servo sectors onto the second portion differs from writing track specific servo sectors onto the first portion as use of the laser beam of the laser based measurement system ceases as the sole feedback source for controlling the position and movement of the HSA during the write operation. The HPCFs written onto servo sectors of the first portion are read by the read element of the read/write head to generate a position error signal (PES) (such as 238) used by the servo control electronics to generate a head position control signal (such as 228). The head position control signal augments the laser based measurement system for controlling the HSA during the servo write operation of the second section. The STW uses the laser loop to position the heads at the correct spacing increments, and uses a ZAP table (such as 238) to augment the position control to increase the “parallelism” between the data track being used to build the ZAP table and the data track using the ZAP table during the servo write process. Parallelism is usually affected by the random and systematic disturbances occurring at the time the data track used to build the ZAP table is being written.

At all times during the write process, the laser is used as the “DC” spacing control for writing the HPCFs, and HSA is connected to the STW push-pin. The position control information from the disc is fed into the laser control loop, via the head position control signal, to cause the laser control loop to track the written-in displacement within the average position of the previously written data track of the previously written portion of the disc surface, resulting in both the written and read tracks having substantially the same written-in disturbances, thereby decreasing what is commonly known as “AC track squeeze”, i.e., maintaining parallelism between the data track being written and the data track being read and improving concentricity of the tracks.

Step 250 represents the final write process of the servo write process. In writing track specific servo sectors to the remaining portions of the disc surface, the STW continues to utilize the servo writing process step employed by the STW in writing track specific servo sectors to the second portion of the disc surface. That is to say, for any portion (n +1) of the disc surface, the STW utilizes the HPCFs written to the preceding portion (n) of the data surface to augment position control of the HSA while writing track specific servo sectors to the portion (n +1).

Step 252 of the servo write process entails turning off the power to the disc drive, allowing the disc drive to spin down, removing the clock head from the disc surface, disconnecting the servo write interface cable from the disc drive and removing the disc drive from the STW. At this point the servo write process ends at process step 254.

Accordingly, the present invention is directed to an apparatus and method for writing track specific servo sectors, including head position control fields to a disc surface. In accordance with one aspect, steps preformed include connecting a disc drive to a position information writing apparatus, for writing the track specific servo sectors including head position control fields to the disc surface, step 244; writing head position control fields on a first portion of the disc surface with a write element of a read/write head while controlling position of the read/write head relative to the first portion using the position information writing apparatus, step 246; and reading the head position control fields of the first portion with a read element of the read/write head to produce a head position control signal that is combined with the position signal of the position information writing apparatus to control position of the write element in relation to a second portion of the disc surface while writing head position control fields on the second portion of the disc surface, step 248. During the servo sector write process the heads 118 (of FIG. 5) are position-controlled or under position control of the STW 160 (of FIG. 3), meaning the position of heads 118 (of FIG. 5) relative to both the disc surface 106 (of FIG. 5) and to the STW 160 (of FIG. 3), are under constant control of the STW 160 (of FIG. 3).

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed in the spirit of the invention disclosed and as defined in the appended claims.

What is claimed is:

1. A method for writing a track specific servo sector to a disc surface of a disc drive comprising steps of:
(a) connecting the disc drive to a position information writing apparatus for writing the track specific servo sector to the disc surface;
(b) positioning a read/write head of the disc drive in relation to a first portion of the disc surface with a position signal of the position information writing apparatus while writing a first track specific servo sector on the first portion of the disc surface using a write element of the read/write head; and
(c) reading the first track specific servo sector of the first portion with a read element of the read/write head to produce a head position control signal, and combining the head position control signal with the position signal of the position information writing apparatus to position the write element in relation to a second portion of the disc surface while writing a second track specific servo sector on the second portion of the disc surface.

2. The method of claim 1 in which the connecting step (a) comprises steps of:
(a1) connecting a connector of an actuator assembly of the disc drive to the position information writing apparatus for communication between the disc drive and the position information writing apparatus during writing of the track specific servo sector to the disc surface of the disc drive;
(a2) attaching a first end of a push-pin to the actuator assembly and a second end of the push-pin to a positioner of the position information writing apparatus, the push-pin providing a mechanical link between the actuator assembly and the positioner during writing of the track specific servo sector; and
(a3) applying power to the position information writing apparatus to initiate writing of the track specific servo sector to the disc surface of the disc drive.

3. The method of claim 1 in which the first portion of the disc surface of positioning step (b) comprises a plurality of data tracks wherein each data track comprises a plurality of head position control fields, and in which the positioning step (b) comprises steps of:
(b1) measuring offset of the write element in relation to the read element for use in determining a number of data tracks corresponding to the plurality of data tracks comprising the first portion of the disc surface;
(b2) holding the write element in a fixed position in relation to the position information writing apparatus while writing the head position control field on the disc surface therein forming a first data track of the plurality of data tracks of the first portion of the disc surface;
(b3) moving the write element to a second position adjacent the first data track of the first portion for formation of a second data track of the plurality of data tracks of the first portion, the second position based on the measured offset of the write element in relation to the read element;
(b4) maintaining the write element in a fixed position in relation to the first data track of the first portion while writing the head position control field on the disc surface therein forming the second data track of the plurality of data tracks of the first portion of the data surface; and
(b5) repeating steps (b3)and (b4)until all head position control fields for each data track of the plurality of data tracks comprising the first portion of the disc surface have been written to the disc surface.

4. The method of claim 1 in which the first portion of the disc surface of the positioning step (b) portion of the disc surface determination comprises steps of:
(bi) measuring an offset of the write element in relation to the read element for use in determining a number of adjacent data tracks comprising the first portion of the disc surface;
(bii) determining the number of adjacent data tracks representing the measured offset of the read element and the write element; and
(biii) controlling position of the write element in relation to the first portion of the disc surface using the position information writing apparatus while writing disc level servo information on each of the adjacent data tracks of the first portion such that when the read element is position-controlled on the first data track of the first portion the write element is position-controlled on a first data track of a second portion of the disc surface.

5. The method of claim 3 in which the plurality of data tracks comprise a number of adjacent data tracks and in which moving step (b3) further comprises steps of:
(b3a) determining the number of adjacent data tracks comprising the first portion of the disc surface; and
(b3b) writing each of the plurality of the head position control field on each of the number of adjacent data tracks of the first portion such that when the read element of the read/write head is position-controlled on a first adjacent data track of the first portion of the disc surface, the write element of the read/write head is position-controlled on a first data track of the second portion of the disc surface.

6. The method of claim 1 in which the first portion of the disc surface of positioning step (b) comprises a plurality of data tracks, each data track providing a plurality of track specific servo sectors having a head position control field, and in which the reading step (c) comprises steps of:
(c1) reading the head position control field of a selected track specific servo sector of the plurality of track specific servo sectors of a selected data track of the plurality of data tracks of the first portion of the disc surface to position-control the read/write head relative to the first portion of the disc surface using the position information writing apparatus;
(c2) transducing a position error signal from the position control field for use in determining position correction of the read element of the read/write head in relation to the selected data track;
(c3) isolating a disturbance acting on the disc surface and determining a level of the head position control signal commensurate with the position correction of the read element in relation to the position information writing apparatus to apply to compensate effects of the isolated disturbance; and
(c4) recording the level of the head position control signal for use in compensating the write element position in relation to the position information writing apparatus while writing a head position control field on the second portion of the disc surface.

7. The method of claim 6 in which the writing portion of reading step (c) further comprises steps of:
(c5) reading the head position control field of the selected data track of the first portion and the recorded head position control signal, for use in correcting the position of the write element in relation to the second portion of the disc surface;
(c6) combining the head position control signal with the position signal of the position information writing apparatus to position-control the write element in relation to the position information writing apparatus; and
(c7) writing the head position control field of the second portion radially offset from the head position control field of the selected track specific servo sector of the plurality of track specific servo sectors of the selected data track of the plurality of data tracks of the first portion of the disc surface by an amount substantially equaling a spacing separating the read element of the read/write head from the write element of the read/write head.

8. The method of claim 1 in which the position information writing apparatus of connecting step (a) is the servo track writer and the produced head position control signal of reading step (c) compensates effects of selective frequencies present during writing of the first track specific servo sector.

9. The method of claim 1 in which the second track specific servo sector of the second portion of reading step (c) is written in substantially radial alignment with the first track specific servo sector of the first portion of writing step (c).

10. The method of claim 3 in which the write element of measuring step (b1) is an inductive element and the read element of measuring step (b1) is a magneto-resistive element.

11. The method of claim 7 in which the head position control field of the second portion of writing step (c7) is a head position control field of a selected track specific servo sector of a plurality of track specific servo sectors of a selected data track of a plurality of data tracks of the second portion of the disc surface written substantially circumferentially aligned to the head position control field of the first portion of writing step (c7).

12. The method of claim 7 in which the head position control field of the second portion of writing step (c7) is a head position control field of a selected track specific servo sector of a plurality of track specific servo sectors of a selected data track of a plurality of data tracks of the second portion of the disc surface written substantially radially aligned to the head position control field of the head position information of the first portion of writing step (c7).

13. A disc drive comprising:
a basedeck supporting a spindle motor assembly;
a rotatable disc surface having an outer diameter and an inner diameter attached to the spindle motor assembly, the disc surface for data storage;
an actuator assembly supported by the basedeck and having a read/write head rotationally positionable adjacent the disc surface, the read/write head comprising a read element for reading data from the disc surface and a write element offset from the read element in one direction across the disc surface from the outer diameter to the inner diameter for writing data to the disc surface; and
a first head position control field stored on a first portion of the disc surface for correcting position of the read element in relation to the first portion and the write element in relation to a second portion of the disc surface while the write element writes a second head position control field to the second portion offset from the first head position control field of the first portion a distance substantially the same as the offset of the write element from the read element by steps for writing the second head position control field to the disc surface.

14. The disc drive of claim 13 in which the read element is separated from the write element by a predetermined spacing, and wherein the read element is substantially radially aligned and substantially circumferentially aligned to the write element.

15. The disc drive of claim 13 in which the first head position control field of the first portion having a geometric shape provides position correction information for position-control of the read element in relation to the first portion while the write element writes the second head position control field to the second portion in conformance with the geometric shape of the first head position control field of the first portion.

16. The disc drive of claim 13 in which the first portion of the disc surface comprises a data track and the head position control field of the first portion comprises an “A” burst adjacent a “B” burst.

17. The disc drive of claim 16 in which the second portion of the disc surface comprises a data track and the head position control field of the second portion comprises an “A” burst adjacent a “B” burst.

18. The disc drive claim 16 in which the head position control field of the first portion and the head position control field of the second portion are offset, substantially radially aligned and substantially circumferentially aligned one to the other wherein the offset is substantially the same as the offset of the read element from the write element of the read/write head.

19. The disc drive of claim 13 in which the write element of the read/write head is an inductive element and the read element of the read/write head is a magneto resistive element.

20. The disc drive of claim 13 in which the steps for writing the second head position control field to the disc surface comprises steps of:
(a) connecting the disc drive to a position information writing apparatus for writing the first head position control field to the disc surface;
(b) positioning the read/write head of the disc drive in relation to the first portion of the disc surface with a position signal of the position information writing apparatus while writing the first head position control field on the first portion of the disc surface using the write element of the read/write head; and
(c) reading the first head position control field of the first portion with the read element of the read/write head to produce a head position control signal, and combining the head position control signal with the position signal of the position information writing apparatus to position-control the write element in relation to the second portion of the disc surface while writing the second head position control field on the second portion of the disc surface.

21. The disc drive of claim 20 in which the connecting step (a) comprises steps of:
(a1) connecting a connector of the actuator assembly of the disc drive to the position information writing apparatus for communication between the disc drive and the position information writing apparatus during writing of the first head position control field to the disc surface of the disc drive;
(a2) attaching a first end of a push-pin to the actuator assembly and a second end of the push-pin to a positioner of the position information writing apparatus, the push-pin providing a mechanical link between the actuator assembly and the positioner during writing of the first head position control field; and
(a3) applying power to the position information writing apparatus to initiate writing of the first head position control field to the disc surface of the disc drive.

22. The disc drive of claim 20 in which the first portion of the disc surface comprises a plurality of data tracks wherein each data track comprises a plurality of the head position control field, and in which the positioning step (b) comprises steps of:
(b1) measuring the offset of the write element in relation to the read element for use in determining a number of data tracks corresponding to a plurality of data tracks comprising the first portion of the disc surface;
(b2) holding the write element in a fixed position in relation to the position information writing apparatus while writing the first head position control field on the disc surface therein forming a first data track of the plurality of data tracks of the first portion of the disc surface;
(b3) moving the write element to a second position adjacent the first data track of the first portion for formation of a second data track of the plurality of data tracks of the first portion, the second position based on the measured offset of the write element in relation to the read element;
(b4) maintaining the write element in a fixed position in relation to the first data track of the first portion while writing the second head position control field on the disc surface therein forming the second data track of the plurality of data tracks of the first portion of the data surface; and
(b5) repeating steps (b3) and (b4) until all head position control fields for each data track of the plurality of data tracks comprising of the first portion of the disc surface have been written to the disc surface.

23. The disc drive of claim 20 in which the first portion comprises a plurality of adjacent data tracks and in which a portion determination of the disc surface utilized by the first portion of the disc surface comprises steps of:
(bi) measuring the offset of the write element in relation to the read element for use in determining a number of adjacent data tracks comprising the first portion of the disc surface;
(bii) determining the number of adjacent data tracks representing the measured offset of the read element and the write element; and
(biii) controlling position of the write element in relation to the first portion of the disc surface using the position information writing apparatus while writing disc level servo information on each of the adjacent data tracks of the first portion such that when the read element is position-controlled on the first data track of the first portion the write element is position-controlled on a first data track of a second portion of the disc surface.

24. The disc drive of claim 22 in which the plurality of data tracks comprise a number of adjacent data tracks and in which moving step (b3) further comprises steps of:
(b3a) determining the number of adjacent data tracks comprising the first portion of the disc surface; and
(b3b) writing each of the plurality of the head position control field on each of the number of adjacent data tracks of the first portion such that when the read element of the read/write head is position-controlled on a first adjacent data track of the first portion of the disc surface, the write element of the read/write head is position-controlled on a first data track of the second portion of the disc surface.

25. The disc drive of claim 20 in which the first portion of the disc surface comprises a plurality of data tracks, each data track providing a plurality of track specific servo sectors having a head position control field, and in which the reading step (c) comprises steps of:
(c1) reading the head position control field of a selected track specific servo sector of the plurality of track specific servo sectors of a selected data track of the plurality of data tracks of the first portion of the disc surface to position-control the read/write head relative to the first portion of the disc surface using the position information writing apparatus;
(c2) transducing a position error signal from the position control field for use in determining position correction of the read element of the read/write head in relation to the selected data track;
(c3) isolating a disturbance acting on the disc surface and determining a level of the head position control signal commensurate with the position correction of the read element in relation to the position information writing apparatus to apply to compensate effects of the isolated disturbance; and
(c4) recording the level of the head position control signal for use in compensating the write element position in relation to the position information writing apparatus while writing a head position control field on the second portion of the disc surface.

26. The disc drive of claim 25 in which the writing portion of reading step (c) further comprises steps of:
(c5) reading the head position control field of the selected data track of the first portion and the recorded head position control signal, for use in correcting the position of the write element in relation to the second portion of the disc surface;
(c6) combining the head position control signal with the position signal of the position information writing apparatus to position-control the write element in relation to the position information writing apparatus; and
(c7) writing the head position control field of the second portion radially offset from the head position control field of the selected track specific servo sector of the plurality of track specific servo sectors of the selected data track of the plurality of data tracks of the first portion of the disc surface by an amount substantially equaling a spacing separating the read element of the read/write head from the write element of the read/write head.

27. The disc drive of claim 20 in which the position information writing apparatus of connecting step (a) is the servo track writer and the produced head position control signal of reading step (c) compensates effects of selective frequencies present during writing of the first head position control information.

28. The disc drive of claim 26 in which the second portion of the disc surface comprises a plurality of data tracks, each data track providing a plurality of track specific servo sectors having a head position control field and in which the head position control field of the second portion of writing step (c7) is the head position control field of a selected track specific servo sector of the plurality of track specific servo sectors of a selected data track of the plurality of data tracks of the second portion of the disc surface written substantially circumferentially aligned to the head position control field of the first portion of writing step (c7).

29. The disc drive of claim 26 in which the second portion of the disc surface comprises a plurality of data tracks, each data track providing a plurality of track specific servo sectors having a head position control field and in which the head position control field of the second portion of writing step (c7) is the head position control field of a selected track specific servo sector of the plurality of track specific servo sectors of a selected data track of the plurality of data tracks of the second portion of the disc surface written substantially radially aligned to the head position control field of the head position information of the first portion of writing step (c7).

30. An apparatus made by steps comprising:
reading head position control information from a first portion of a rotatable disc surface with a read element of a read/write head to produce a head position control signal; and
a step for combining the head position control signal with a position signal of to position-control the read element of the read write/head relative to the first portion while writing head position control information on a second portion of the disc surface with a write element of the read/write head.
